(19) United States
(12) Patent Application Publication
(10) Pub. No.: US 2015/0188839 A1
(43) Pub. Date: Jul. 2, 2015

(54) VIRTUALIZATION IN A STORAGE AREA NETWORK

(71) Applicant: EMC Corporation, Hopkinton, MA (US)

(72) Inventor: Zheng Zhang, Shanghai (CN)

(21) Appl. No.: 14/573,228

(22) Filed: Dec. 17, 2014

(30) Foreign Application Priority Data
Dec. 27, 2013 (CN) CN201310755995.8

(51) Int. Cl. H04L 12/911; G06F 9/455

(52) U.S. Cl. CPC H04L 47/70; G06F 9/455

(57) ABSTRACT

Embodiments of the present invention provide a storage device and a method therefor, the storage device comprising at least one port and a plurality of storage resources. In the storage device, the plurality of storage resources are divided into a plurality of storage resource sets, and each of the plurality of storage resource sets is configured to be associated with one or more ports of the at least one port, such that each of the storage resource sets can be accessed only through the one or more ports associated with it.

### RELATED APPLICATION

This Application claims priority from Provisional Application Ser. No. CN201310755995.8 filed on Dec. 27, 2013 entitled “STORAGE DEVICE AND METHOD THEREFOR,” the content and teachings of which are hereby incorporated by reference in their entirety.

### TECHNICAL FIELD

Embodiments of the present disclosure relate generally to the field of storage, and particularly to port virtualization in a storage area network (SAN), and more particularly to a storage device based on N_port identifier (ID) virtualization (NPIV) technology and a method used for the storage device.

### BACKGROUND OF THE INVENTION

With the development of cloud computation technology, cloud infrastructures are being widely used. No matter in a private cloud or in a mixed cloud, multi-tenancy is an important attribute among various others factors. Thus, in a cloud environment, one objective that the current cloud computation or multi-tenancy technology pursues is on how to effectively protect the privacy and security of data for individual tenants. The “tenant” used herein may refer to any application, which may be an application inside or outside an enterprise, and needs its own secure and exclusive virtual computation environment.

In the cloud environment supported by a SAN, the Fiber Channel (FC) protocol is usually used to access the storage device to accommodate a number of requirements for throughput capacity and reliability of virtual machines (VMs) belonging to different tenants. The fiber channel is typically a high speed protocol with powerful functions, adapted for SAN information transmission and management. The fiber channel is an effective solution for a large-scale and intensive storage system, capable of achieving fast storage and search of information while simplifying interconnection between different parts of the system.

NPIV is one feature defined in the fiber channel protocol, used for the purpose of making a host server in the virtual environment connect with the SAN environment more flexibly and securely, and also in simplifying the framework of the SAN network. NPIV is widely used in products such as FC Host bus adapter (HBA) cards. NPIV may virtualize a physical N_port (the N_port is defined as a connection port connected to the fabric from the host side or the storage array side) of one entity into several virtual N_port IDs, such that one host may have one or more FC addresses and worldwide port names (WWPNs) associated therewith, each FC address represented as an independent entity on the SAN fabric structure. As illustrated in FIG. 1, when one host has a plurality of virtual machines, each virtual machine (VM) is associated with a different N_port ID, as if being connected with the SAN fabric via FC links which are independent from one another, so that it is possible to separate connections of different virtual machines in the SAN environment.

In the current SAN environment, port virtualization is generally implemented only at the application side, and each virtual machine may be associated with one independent port ID, for example each virtual machine may be bonded with a unique WWPN, such that it may be addressed independently on the fabric. However, at the storage side in the conventional SAN environment, data from hosts belonging to different tenants are received into individual storage devices through a shared port, i.e., storage resources on the storage device are not separated amongst the individual tenants, and the same storage resource can be accessed by different tenants, such that in a multi-tenant environment, the privacy and security of the tenant data cannot be assured reliably and it is becomes difficult to achieve consistent migration of the storage data and applications.

### SUMMARY OF THE INVENTION

In view of the above mentioned disadvantages, exemplary embodiments of the present disclosure provide a storage device based on the NPIV technology that ameliorates the one or more of the current disadvantages in such a system.

According to an embodiment of the present disclosure, there is provided a storage device that includes at least one port; and a plurality of storage resources, the plurality of storage resources being divided into a plurality of storage resource sets and each of the plurality of storage resource sets is configured to be associated with one or more ports of the at least one port, such that each of the plurality of storage resource sets may be accessed only through the one or more ports associated with it.

In a further embodiment, each of the at least one port may have an independent worldwide port name WWPN as an identifier.

In a further embodiment, each of the at least one port may be a physical fiber channel port.

In yet a further embodiment, each of the plurality of storage resource sets may be configured as a storage group, which includes a plurality of logical volumes (hereinafter also referred to as LUN or Logic Unit Number).

In a further embodiment, each of the at least one port may include one of a physical fiber channel port and a plurality of virtual ports generated by virtualizing the fiber channel physical port.

In a further embodiment, each of the plurality of storage resource sets may be configured to be associated with at least one of the virtual ports.

In a further embodiment, the fiber channel physical port is virtualized into a plurality of virtual ports by using the N_port ID virtualization (NPIV) protocol.

In yet a further embodiment, one or more ports associated with one of the plurality of storage resource sets do not overlap with one or more ports associated with another storage resource set, wherein the other storage resource set is different from the plurality of storage resource sets.

According to another embodiments of the present disclosure, there is provided a method used for a storage device, with the storage device comprising at least one port and a plurality of storage resources, which includes dividing the storage resources into a plurality of storage resource sets; and configuring each of the plurality of storage resource sets to be associated with one or more ports of the at least one port, such that each of the plurality of storage resource sets may be accessed only through the one or more ports associated with it.

The storage device according another embodiments of the present disclosure may have a plurality of port IDs, so as to exclusively possess a plurality of FC addresses and associated WWPNs on the SAN fabric, and the storage resource with such FC addresses and WWPNs has a relationship in a network environment that is consistent with that in a conventional computation environment, and hence the conventional FC management function may be kept unchanged. Thus, without increasing the complexity of the system, it is possible to realize port virtualization on the storage device, so as to achieve, in a multi-tenancy environment, security with a finer granularity for separating tenant data.

### BRIEF DESCRIPTION OF THE DRAWINGS

The features, advantages and other aspects of the embodiments of the present disclosure will become more obvious in conjunction with the drawings and by referring to the following detailed description. Several embodiments of the present disclosure are illustrated in an exemplary but non-limiting manner. In the drawings, the same or similar reference numerals represent the same or similar unit or element, in which:

FIG. 1 illustrates a NPIV in the prior art SAN network;

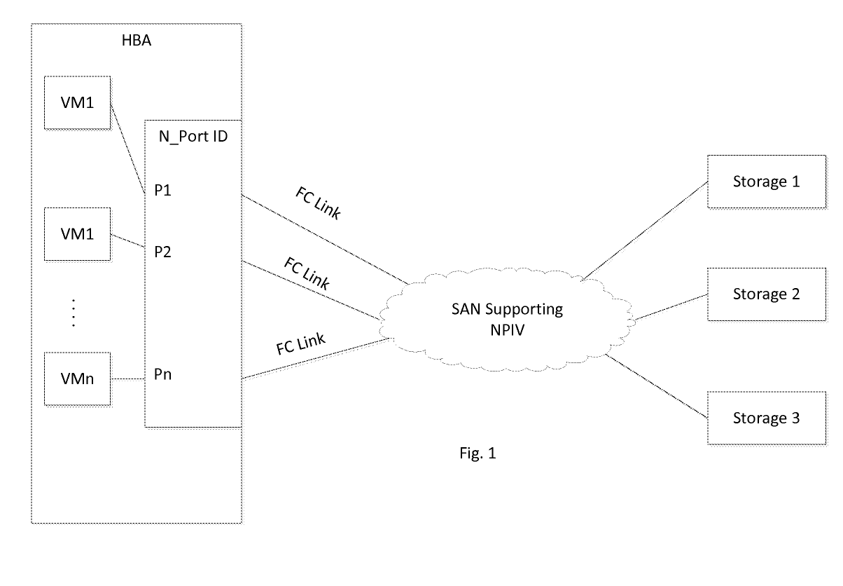

FIG. 2 illustrates a network structure supporting the NPIV as in the prior art;

FIG. 3 shows an exemplary network structure using a storage device according to embodiments of the present disclosure; and

FIG. 4 shows an exemplary flowchart of a method used for a storage device according to embodiments of the present disclosure.

### DETAILED DESCRIPTION OF EMBODIMENTS

In the following, individual exemplary embodiments of the present disclosure are described in detail with reference to the drawings.

It should be understood that these exemplary embodiments are provided merely for the purpose of facilitating those skilled in the art to better understand and then embody the present disclosure, rather than limiting the scope of the present disclosure in any way.

In the following description, the reference to “one embodiment”, “another embodiment” or “one preferred embodiment” and the like indicates that the described embodiment may comprise specific features, structures or characteristics, while it is not necessary that each embodiment has to include such specific features, structures or characteristics. Also, it is not necessary that these terms refer to the same embodiment.

The terms as used herein are only used for the purpose of describing a particular embodiment, rather than limiting the present invention. The singular form, “a” or “the”, may include the plural form, unless the context expressly indicates otherwise. It should be also understood that the terms, “comprise”, “have” and “contain” and derivatives thereof, as used herein, refer to the presence of said feature, unit and/or component and the like, but not excluding the presence of one or more of other features, units, components and/or combination thereof.

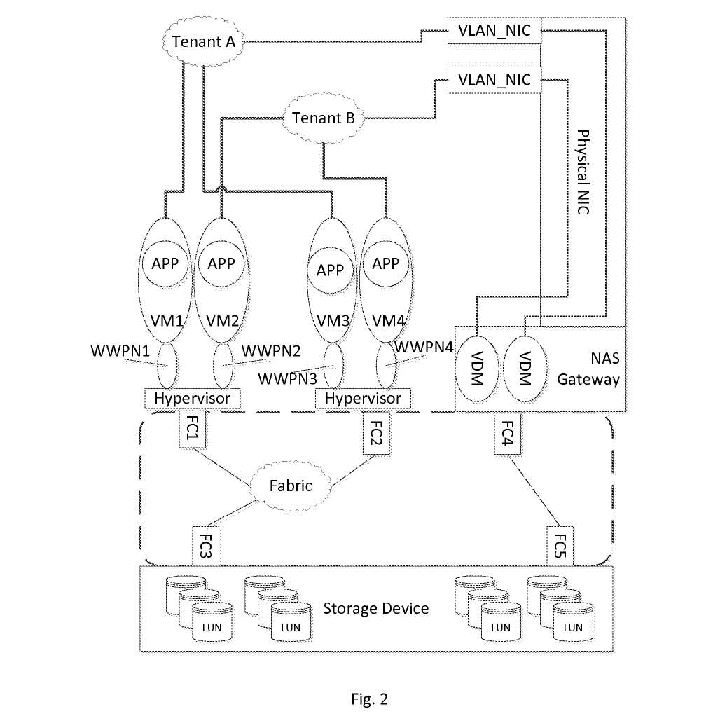

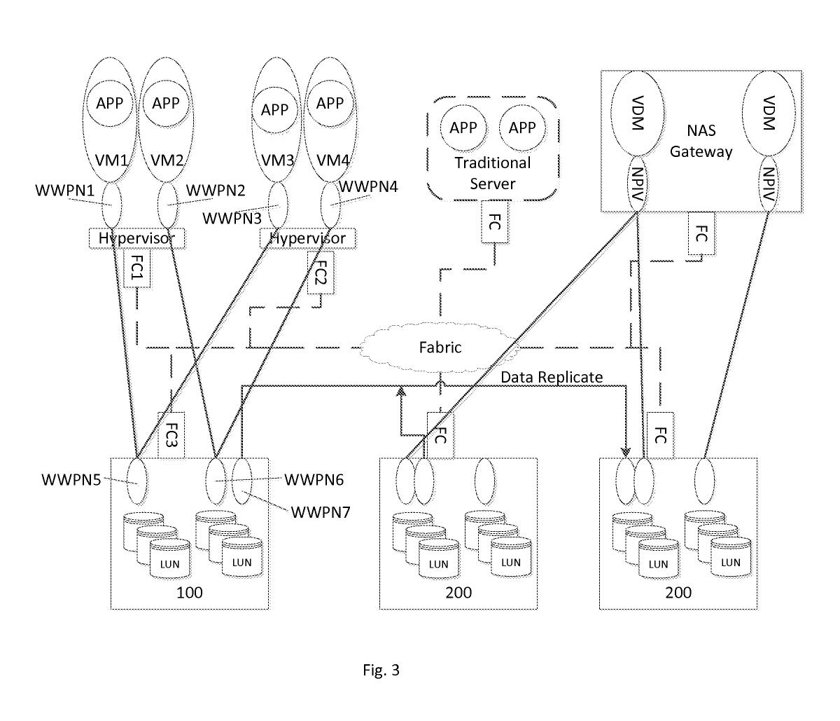

Embodiments of the present disclosure will be set forth in detail by referring to FIGS. 2-3 as follows.

Firstly, reference is made to FIG. 2. FIG. 2 depicts a network structure supporting the NPIV as in the prior art. FIG. 2 schematically shows two tenants A and B, which are respectively represented by a square pattern and an oblique line pattern. Each of the tenants A and B, uses two applications or virtual machines (VMs) respectively. Each VM is associated with one virtual port generated by the NPIV virtualization and connected with the SAN fabric. Each virtual port has a single unique addressing identity (ID), for example WWPN, which may serve as the address on the SAN network to be addressed. As shown in FIG. 2, the tenant A uses the virtual machines VM1 and VM3, which are respectively connected to the fabric through the virtual ports WWPN1 and WWPN3, and the tenant B uses the virtual machines VM2 and VM4, which are respectively connected to the fabric through the virtual ports WWPN2 and WWPN4. Although two tenants are shown in FIG. 2 and each tenant uses two virtual machines, one skilled in the art should understand that these numbers are only exemplary, rather than limiting, and the scope of the present disclosure is not limited by the number of the tenants or the VMs, or connection manners.

Additionally, a management program that is exemplarily shown between the SAN network and the virtual machines in FIG. 2 and may be referred to as Hypervisor, which is an intermediate software layer between the basic physical server and the operating system, and an “element” operating system in the virtual environment. It can access all of the physical devices on the server, including the disk and the memory. When the server is started and executes the management program, it will be loaded with operating systems of all virtual machine clients and meanwhile each virtual machine will be assigned with an appropriate amount of memory, CPU, network and disk. The management program, such as Hypervisor, has been widely used in the existing virtual network environment, and therefore it will not be described in detail herein.

In FIG. 2, the data received from the tenants A and B respectively via the virtual ports WWPN1-4 is switched by the fabric and enters the storage side of the SAN through the FC port, FC3. The data enters the SAN storage device through the port FC3, and in the storage device, the data received through the port FC3 is not separated, while it is on the storage group to configure and identify the port ID (for example, WWPN1-4) from where the data is originating, so as to control the storage resource that it can access, e.g. LUN. This way is adverse to deploying a large amount of virtual machines using different WWPNs and applications in the cloud environment.

In addition, the data received from the tenant A and the tenant B through the network interface card NIC enters the SAN storage device through the FC ports, FC4 and FC5. Similarly, the data received through port FC5 is not separated in the storage device, while it is separated on the storage group to configure and identify the port ID (for example, WWPN1-4) from where the data originates, so as to control the storage resource which it can access, e.g. LUN.

In the multi-tenant environment, the manner for storing data such that the data of different tenants is not distinguished does not ensure the security and privacy of the tenant data, and it is therefore not beneficial to the rapid migration and recovery of data.

FIG. 3 shows an exemplary network structure using the storage device according to embodiments of the present invention. Both of the fabric as shown in FIG. 3 and the SAN network mentioned below are those supporting the port virtualization, for example, supporting the NPIV. FIG. 3 does not explicitly show the tenant A and the tenant B, but the patterns identical to those as showed in FIG. 2 are used to indicate the virtual machines and storage resources associated with different tenants and the like, that is, using the square pattern to indicate the virtual machine and storage resource associated with the tenant A, and using the oblique line pattern to indicate the virtual machine and storage resource associated with the tenant B, and so on.

In this embodiment, each SAN storage device, e.g. the storage device 100, 200 or 300 as shown in FIG. 3, includes at least one physical port, e.g. the fiber channel FC port, and each physical port may have a unique identifier WWPN on the SAN fabric. Each physical port may be virtualized into a plurality of virtual ports, for example, by the NPIV method. After the virtualization, the storage device may have independent port IDs, a maximum number of which is equal to the sum of the number m of the physical ports and the number n of the virtual port IDs generated by the virtualization (maximum number=m+n). This implies that , after the port virtualization, the storage device may have m+n different port IDs, i.e., there are m+n FC addresses that may be independently addressed on the SAN fabric.

Meanwhile, each SAN storage device 100, 200 or 300 includes a plurality of storage resources, for example, a plurality of logical volumes that are identified with LUNs. These logical resources may be divided into a plurality of logical resource sets, for example, a plurality of logical volumes LUNs may be divided into a plurality of storage groups (SGs). In the storage device, each of the plurality of storage resource sets (hereinafter also referred to as storage resource set) is configured to be associated with one or more ports (m+n ports at most). Each of the one or more ports may be a physical port, or may be one of the virtual ports generated by virtualizing the physical port, wherein each port has a single unique ID, for example, a WWPN.

In one embodiment of the present disclosure, the port of the storage device and the storage resource set may be bound and combined into a storage container. In the case of multiple tenants (multi-tenancy), the physical FC port ID or virtual port ID used for the host (a physical machine or virtual machine) of a particular tenant can be securely bound with the physical FC port ID or virtual port ID for the storage container through the FC zoning, so as to establish an effective security boundary between the data of the tenant and the application. The FC zoning as used herein refers to a technology for dividing the FC fabric into smaller subsets to restrain interference, increase security and simplify management. Although a SAN can be used for a plurality of devices and/or a plurality of ports of a single device, each system connected to the SAN should be permitted to access only the controlled subsets of these devices or ports. The FC zoning is commonly used technology in the existing SAN networks, and therefore it is not described in detail here.

In a preferred embodiment, one or more ports associated with different storage resource sets do not overlap, so as to guarantee sufficient data separation, and thus achieve higher security and privacy.

Hereinafter, the structure and functions of the storage device according to embodiments of the present disclosure is described in detail, with storage device 100 illustrated in FIG. 3 as an example. As illustrated in FIG. 3, the storage device 100 comprises a physical port FC 3, which may have a unique identifier such as a WWPN on the SAN fabric. FC 3 port may be virtualized into 3 virtual ports, which have identifiers, WWPN5, WWPN6 and WWPN7, respectively. After the port virtualization, the virtual device 100 may have 4 different port IDs, i.e., 4 FC addresses on the SAN fabric, which can be independently addressed.

Meanwhile, the storage device includes two storage resource sets, i.e., storage groups SG1 and SG2. Each storage group comprises a plurality of logical volumes LUNs. In this embodiment, the storage group SG1 is associated with the virtual port WWPN5, and the storage group SG2 is associated with the virtual ports WWPN6 and WWPN7, the storage group SG1 can be accessed through the virtual port WWPN5 only, and the storage group SG2 can be accessed through the virtual ports WWPN6 and WWPN7 only.

In one embodiment, through the FC zoning, the virtual port IDs WWPN1 and WWPN3 associated with VM1 and VM3 of tenant A can be bound with the virtual port ID WWPN5 associated with SG1, and the virtual port IDs WWPN2 and WWPN4 associated with VM2 and VM4 of tenant B can be bound with the virtual port ID WWPN6 associated with SG2, such that the data coming from (being transmitted) or going to (being received) tenant A is completely separated from the data coming from or going to tenant B. For example, the data transmitted from tenant A can be received and processed only by the storage group SG1, and the data transmitted from the tenant B can be received and processed only by the storage group SG2. FIG. 3 shows a preferred embodiment for the storage device 100, wherein the port ID associated with the storage group SG1 does not overlap with the port ID associated with the storage group SG2, so as to guarantee higher security and privacy.

In addition, the physical FC port on the application side, e.g. FC1 or FC2, also has its unique ID on the SAN, for example, WWPN. These physical ports may be coupled with the physical port (e.g. FC3 and its WWPN) or the virtual port (e.g. WWPN7) of the storage device through the fabric.

In the embodiment as shown in FIG. 3, at one port on the SAN application side, regardless of a physical port or a virtual port, its identifier ID may be associated or bound with different port IDs (including physical port IDs or virtual port IDs) of a plurality of different storage containers in the plurality of storage devices on the storage side, so as to achieve the safe and redundant storage of data.

In one embodiment, the physical ports of the server on the application side, which do not undergo the port virtualization operation, may also be associated or bound with the virtual port ID of the storage container in the storage device.

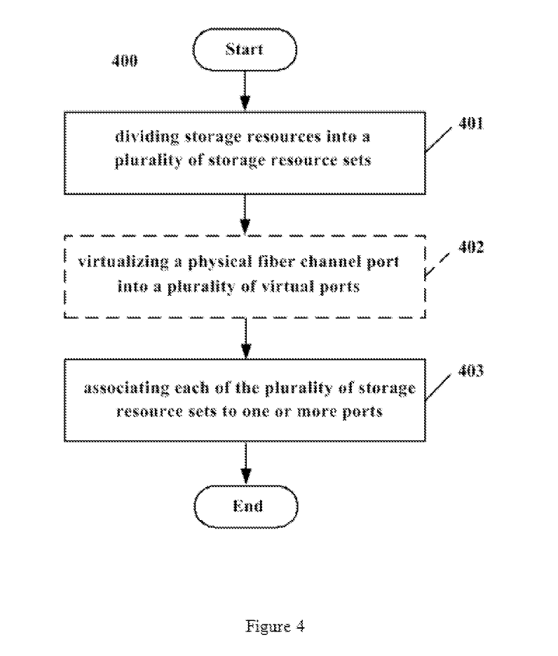

FIG. 4 illustrates a flowchart of an exemplary method 400 used for the storage device according to embodiments of the present disclosure, with the storage device comprising at least one port and a plurality of storage resources.

As shown in FIG. 4, the method 400 includes: dividing the plurality of storage resources into a plurality of storage resource sets in block 401; and then configuring, in block 403, each of the plurality of storage resource sets to be associated with one or more ports of the at least one port, such that each storage resource set can be accessed only through one or more ports associated with it.

In one embodiment, each of the at least one port comprised in the storage device may be a physical port, for example, a physical FC port, or a virtual port generated by virtualizing the physical port.

Additionally, the method 400 may further include in block 402: virtualizing each physical port, e.g. the physical FC port, into a plurality of virtual ports based on the N_port ID virtualization NPIV protocol.

In another embodiment, each of the plurality of storage resource sets included in the storage device may be configured to include a plurality of storage groups of logical volumes (LUN).

In the above, the embodiments according to the present disclosure are described based on the FC-SAN, however one skilled in the art should understand that the present disclosure is not restricted by any particular and specific application environment. Any virtual or non-virtual environment where the storage device is used may use the storage device or method according to the embodiments of the present disclosure.

The storage device according to the embodiments of the present disclosure can have a plurality of port IDs, so as to exclusively possess a plurality of FC addresses and

WWPNs associated with them on the SAN fabric. The relationship of the storage resource having the FC addresses or WWPNs in the network environment is consistent with that in the conventional computation environment, thus the conventional FC management function may be kept unchanged while in use. Therefore, in the case of the system complexity not increasing, it is possible to achieve the port virtualization on the storage device, such that in the multi-tenant environment, security with finer granularity is obtained for separating data of tenants.

Those skilled in the art should recognize that any structural diagram described herein represents illustrative diagram for implementing the principle of the present disclosure. Similarly, it shall be understood that the flowchart described herein represents various procedures that may be embodied in a computer readable medium and executable by a computer or processor, regardless of whether such a computer or processor is illustrated explicitly.

Those skilled in the art should also recognize that individual steps of the above method can be executed by a programmed computer. Herein, some embodiments are also intended to cover program storage devices, for example, a machine or computer readable digital data storage medium comprising instruction programs executable by coded machines or computers, wherein the instruction programs executing part or all of above described method steps. The program storage device may be, for example, digital storage, a magnetic storage medium, such as a disk and a tape, and disk driving or optical readable digital data storage medium. The present embodiments are also intended to cover a computer that is programmed to execute the steps of the above described method.

Those skilled in the art should also recognize that individual steps of the above method 400 can be embodied by any devices, means or machines not shown in the figures comprising “processor” or “controller”, for example, a host server. Various functions of the processor or controller can be provided by using special hardware and hardware which can execute software in association with proper software. When provided by a processor, these functions can be provided by a single special processor, a single shared processor or a plurality of independent processors, wherein some independent processors can be shared. Additionally, the term “processor” or “controller” explicitly used herein should not be construed as exclusively referring to the hardware capable of executing software, but implicitly including, not limited to, digital signal processor (DSP) hardware, a network processor, a special integrated circuit (ASIC), a field programmable gate array (FPGA), a read-only memory (ROM) used for storing software, a random access memory (RAM) and a nonvolatile storage. It can also comprise other hardware common and/or customized.

The above description with reference to the drawings is given exemplarily only for the purpose of explaining the present disclosure. Those skilled in the art can understand that various structures may be proposed based on the principle of the present disclosure mentioned above. Although these different structures are not described or illustrated explicitly herein, they all reflect the principle of the present disclosure and are included in the spirit and scope of the present disclosure. Additionally, all examples mentioned herein are explicitly used for teaching purpose only, to help readers understand the principle and concepts of the present disclosure that the inventor contributes to the prior art, rather than being interpreted as limiting the scope of the present disclosure. Moreover, the principle, aspects and embodiments of the present disclosure mentioned herein and their description and specific examples are covered in the equivalent thereof.

What is claimed is:

1. A storage device, comprising:
at least one port; and
a plurality of storage resources, wherein the plurality of storage resources are divided into a plurality of storage resource sets, and each of the plurality of storage resource sets is associated with one or more ports of the at least one port, such that each of the plurality of storage resource sets can be accessed only through the one or more ports associated with it.

2. The storage device according to claim 1, wherein each of the at least one port is associated with an independent World Wide Port Name (WWPN) as an identifier.

3. The storage device according to claim 1, wherein each of the at least one port comprises a physical fiber channel port.

4. The storage device according to claim 1, wherein each of the plurality of storage resource sets comprises a plurality of storage groups of logical volumes (LUN).

5. The storage device according to claim 3, wherein each of the at least one port comprises one of the physical fiber channel port and a plurality of virtual ports generated by virtualizing the fiber channel physical port.

6. The storage device according to claim 5, wherein each of the plurality of storage resource sets is associated with at least one of the virtual ports.

7. The storage device according to claim 5, wherein the fiber channel physical port is virtualized into the plurality of virtual ports using an N_port virtualization identifier (NPIV) protocol.

8. The storage device according to claim 1, wherein the one or more ports associated with one of the plurality storage resource sets do not overlap with the one or more ports associated with another storage resource set, the another storage resource set being different from the plurality of storage resource sets.

9. A method for virtualization of a storage device, the storage device comprising at least one port and a plurality of storage resources, the method comprising:
dividing the plurality of storage resources into a plurality of storage resource sets; and
configuring each of the plurality of storage resource sets to be associated with one or more ports of the at least one port, such that each of the plurality of storage resource sets can be accessed only through the one or more ports associated with it.

10. The method according to claim 9, wherein each of the at least one port is associated with an independent World Wide Port Name (WWPN) as an identifier.

11. The method according to claim 9, wherein each of the at least one port comprises a physical fiber channel port.

12. The method according to claim 9, wherein each of the plurality of storage resource sets comprises a plurality of storage groups of logical volumes (LUN).

13. The method according to claim 11, wherein each of the physical fiber channel ports is virtualizing into a plurality of virtual ports.

14. The method according to claim 13, wherein configuring each of the plurality of storage resource sets to be associated with at least one port of the plurality of ports comprises:
configuring each of the plurality of storage resource sets to be associated with at least one of the virtual ports.

15. The method according to claim 13, further comprises:
virtualizing each of the physical fiber channel ports into the plurality of virtual ports by using an N_port virtualization identifier (NPIV) protocol.

16. The method according to claim 9, wherein the one or more ports associated with one of the storage resource sets do not overlap with the one or more ports associated with another storage resource set, the another storage resource set being different from the plurality of storage resource sets.

17. A computer program product for virtualization of a storage device, the storage device comprising at least one port and a plurality of storage resources, the computer program product being tangibly stored in a non-transient computer readable medium and including machine executable instructions, the machine executable instructions, when being executed, causing a machine to:
divide the plurality of storage resources into a plurality of storage resource sets, wherein each of the plurality of storage resource sets comprises a plurality of storage groups of logical volumes (LUN); and
configure each of the plurality of storage resource sets to be associated with one or more ports of the at least one port, such that each of the plurality of storage resource sets can be accessed only through the one or more ports associated with it, and wherein the one or more ports associated with one of the storage resource sets do not overlap with the one or more ports associated with another storage resource set, the another storage resource set being different from the plurality of storage resource sets.

18. The computer program product according to claim 17, wherein each of the at least one port is associated with an independent World Wide Port Name (WWPN) as an identifier.

19. The computer program product according to claim 17, wherein each of the at least one port comprises a physical fiber channel port; and wherein each of the physical fiber channel ports is virtualizing into a plurality of virtual ports, and virtualizing each of the physical fiber channel ports into the plurality of virtual ports by using an N_port virtualization identifier (NPIV) protocol.

20. The computer program product according to claim 13, wherein configuring each of the plurality of storage resource sets to be associated with at least one port of the plurality of ports comprises:
configuring each of the plurality of storage resource sets to be associated with at least one of the virtual ports.
